(19) United States
(12) Patent Application Publication
(10) Pub. No.: US 2009/0007256 A1
(43) Pub. Date: Jan. 1, 2009

(54) Using a trusted entity to drive security decisions

(75) Inventors: Michael Raymond, Kenmore, WA (US); Yu Chen, Redmond, WA (US); Wei Wang, Issaquah, WA (US); Mark T. Hanson, Woodinville, WA (US); Jonathan David Schwartz, Redmond, WA (US); Kenneth W. Sykes, Oakton, VA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/823,579

(22) Filed: Jun. 28, 2007

(51) Int. Cl. H04L 9/32

(52) U.S. Cl. 726/19; 726/17

(57) ABSTRACT

An arrangement is provided for programmatically responding to a privilege request on behalf of a user by pre-configuring a trusted entity with a list of processes requiring elevated user credentials and a set of user's credentials having such privilege. The trusted entity determines if a requested process is included in the list of processes, and responds to the privilege requests generated by the kernel of the operating system for such processes, eliminating the need for the user to manually authenticate using some type of input mechanism.

### BACKGROUND

Companies and individuals currently face the challenge of maintaining control over their computers in response to constantly evolving security threats. A balance between maintaining computer security while enabling user productivity must be considered by IT administrators. While many operating system users run with administrative privileges in both the enterprise and the home, running as an administrator results in a desktop that is hard to manage and has the potential for high support costs. Deploying desktops with standard user permissions can result in cost savings because a non-administrative user no longer has the ability to accidentally or improperly configure the network or install an application that might affect system stability. However, running without administrative privileges is challenging today since many applications fail to run and end users get frustrated by the inability to perform common tasks such as adding printers or changing the local time zone.

Currently, when a user of the Windows operating system, for example, wants to launch a process or perform a task that requires administrative privileges, such as installing an application, the user is prompted by the system for permission or for credentials, depending on the security policy that is chosen (requiring the user to enter the credentials (if the user possesses such credentials) or to have an administrator authorize the task by entering their credentials). Or, if a user wants to run a process that requires more privilege than what they currently have, when they launch the process (such as, in Microsoft Windows™, the “disk defragmenter”, which requires administrative privileges, or any process that requires administrative privileges, debug privileges, backup privileges or more privilege that the user does not currently have), again, the system will prompt the user for additional authentication to launch the requested process.

For example, a user is currently logged into the system. The user would like to launch/run a specific process, e.g., the disk defragmenter—which requires more privilege than the current user has. The system will provide a message indicating that access has been denied, and the operating system will then create a request or “prompt” to the user for increased privilege (by entering the appropriate “credentials”) that will allow the process to launch successfully, or, for a separate set of credentials to launch the process as, essentially, the other user. The prompt to the user may consist of a user interface that presents a question to authenticate using alternate means, such as a user name and password, a smart card, biometric or any other type of credential input, etc. The user must then answer the system's request for higher privilege in order to launch the process, after which the process is launched with the appropriate, higher privilege.

More specifically, in the Windows™ Disk Defragmenter tool, although any user can gain access to the Disk Defragmenter console, the ability to analyze or defragment a volume requires administrator privileges. If the user does not have administrator privileges and attempts to use Disk Defragmentor, he will receive a message indicating that “a user must have Administrator privileges to defrag a volume”. Disk Defragmenter was designed primarily for stand-alone workstations or servers whose users have the ability to log on locally with administrator privileges. Disk Defragmenter was not intended to be a tool for administrators to maintain networked workstations and is not designed to be run remotely and cannot be scheduled to automatically defragment a volume without interaction from a logged-on user. The only way a non-administrator can defragment a local volume is to run the Dfrg.msc console in the context of a user who has administrator privileges.

However, again, the user is prompted for the administrator password. This command may be useful for an administrator who wants to run a defragmentation on a user's computer without forcing the user to log off.

In addition, the concept of least privilege is well recognized in computer security. Essentially, if a task or process is launched by a user having more privilege than necessary to do that task, there is the increased risk that the user may inadvertently do some harm to computer resources. For example, if a set of files can only be deleted by a user with administrator privileges, then an administrator may inadvertently delete those files while performing a different task. If the administrator had been a user having lesser privileges, the intended task could still have been performed, but the inadvertent deletion of files would not have been allowed. As a result, it is not always desirable to provide a user with complete administrative privileges.

Unfortunately, the increasing need for enhanced security often requires the presence of a user to authorize access credentials or other authentication means.

In addition, it is becoming more and more common for processes to operate without a user being physically present at the computer. For example, in an end-to-end automated testing scenario, there is no user present at the machine.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement for programmatically responding to a privilege request on behalf of a user is provided by a trusted entity. More specifically, once the trusted entity is installed, which requires administrative privileges, a local user with standard permissions can pre-configure the trusted entity within the operating system with a list of processes requiring elevated user credentials and a set of user's credentials having such privilege, such that the trusted entity can then programmatically answer security questions presented to the user upon an attempt to launch a process on the list. Upon receipt of the further authentication, the process is launched, then running with the appropriate higher privilege.

In particular, the system service (or “trusted entity”) programmatically responds to privilege requests generated the operating system, eliminating the need for the user to manually authenticate using some type of input mechanism, by acting as an intermediary between a user requesting authorization to launch a process requiring a certain level of privilege (e.g., an administrative action) and the operating system. The system service is used to provide or deny access to any aspect of the operating system for any particular user. The information required to make these decisions is available in a data store that the system service accesses.

More generally, the system service maintains a list of pre-configured “answers” to security questions (e.g., a list of processes that are allowed to run elevated) and has the ability to answer the privilege request from the system programmatically on the user's behalf. In one specific implementation, the process runs as a service in the context of the system. The service has a storage mechanism that may be called the “allowed list”. This list contains information about the processes whose security decisions will be automated by the system service. The information may include process identification, such as the name or a hash of the binary, a set of user's credentials that are known to have enough privilege and rights to run the specific process, etc. The system service also includes an input mechanism that allows users to send the information necessary to configure and query the information in the allowed list.

This Summary is provided to introduce a selection of concepts in a simplified form that is further described below in the Detailed Description. This summary is not intended to identify key features or essential features of the claimed subject matter, nor is it intended to be used as an aid in determining the scope of the claimed subject matter. Additional features and advantages will be made apparent from the following detailed description that proceeds with reference to the accompanying drawings.

### DESCRIPTION OF THE DRAWINGS

FIG. 1 is a block diagram representing an exemplary computer system into which the proposed arrangement for providing an automatic, programmable response to a privilege request may be incorporated;

FIG. 2 is a block diagram illustrating an exemplary architecture of the Windows® operating system;

FIG. 3 is a block diagram illustrating the privilege automation service;

FIG. 4 is a state diagram illustrating the privilege automation service as implemented within the operating system for programmatically responding to a privilege request on behalf of a user; and

FIG. 5 is a flowchart of an illustrative method of using a trusted service to drive security decisions across different security boundaries.

### DETAILED DESCRIPTION

The following description relates to implementations of a trusted entity into an operating system, to programmatically drive security decisions presented to a user. The implementation into an operating system is not limited to any particular type of operating system, and may be operating systems provided by Microsoft Corp. under the trade name Windows (e.g., Windows NT®, Windows XP®, Windows 2000®, Windows Vista™). Additionally, the operating system may be an open source operating system such operating systems distributed under the LINUX™ trade name, or a MAC OS® graphical user-interface based operating system, for example. For convenience, however, embodiments are generally described herein with relation to Windows®-based systems. Those skilled in the art can easily adapt these implementations for other types of operating systems or computer systems.

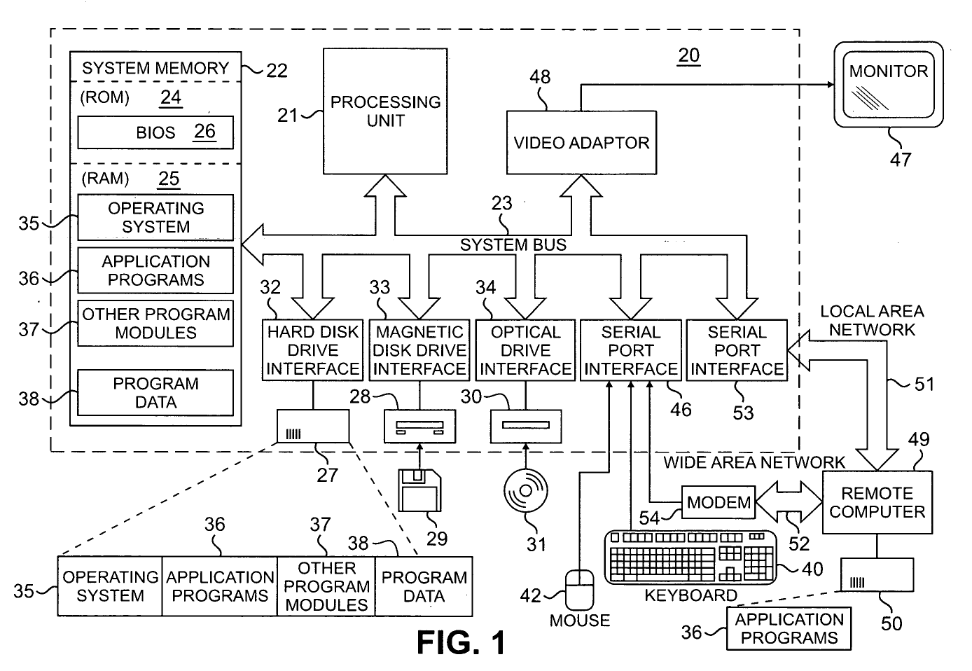

FIG. 1 and the following discussion are intended to provide a brief general description of a suitable computing environment in which the privilege automation service may be implemented. The computing environment is not intended to suggest any limitation as to scope of use or functionality of the described embodiments, as the privilege automation service may be implemented in diverse general-purpose or special-purpose computing environments. Although not required, the privilege automation service will be described in the general context of computer-executable instructions, such as program modules, being executed by a personal computer. Generally, program modules include routines, programs, objects, components, data structures and the like that perform particular tasks or implement particular abstract data types. Moreover, those skilled in the art will appreciate that the privilege automation service may be practiced with other computer system configurations, including hand-held devices, multi-processor systems, microprocessor-based or programmable consumer electronics, network PCs, minicomputers, mainframe computers and the like. The privilege automation service may also be practiced in distributed computing environments where tasks are performed by remote processing devices that are linked through a communications network.

With reference to FIG. 1, an exemplary system for implementing the proposed capabilities of the privilege automation service includes a general purpose computing device in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 (preferably Windows NT), one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, Intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

The implementation of the privilege automation service is not limited to a Windows operating system, but on the contrary, is intended to operate with and provide benefits with any mechanism that performs security checks at the operating system level.

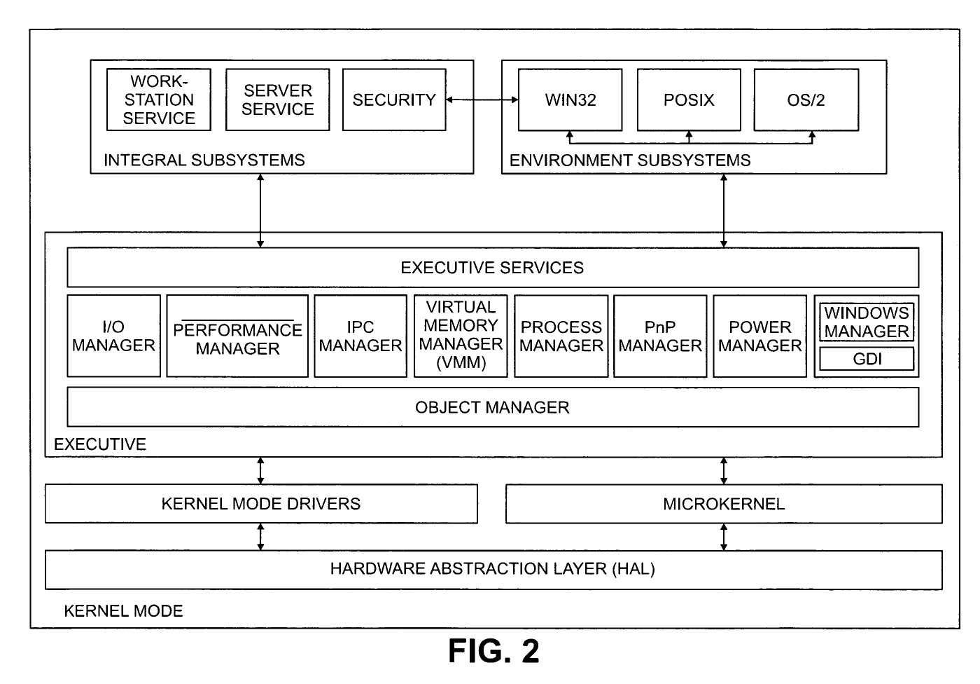

Again, Windows Vista™, Windows Server® 2003, Windows XP®, Windows 2000™ and Windows NT® are all part of the Windows NT® family of Microsoft operating systems. The architecture of Windows NT is highly modular, and consists of two main layers, a User Mode and a Kernel Mode. Programs and subsystems in User Mode are limited in terms of what system resources they have access to, while the Kernel Mode has unrestricted access to the system memory and external devices. As illustrated in FIG. 2, in Kernel Mode, the architecture comprises a hybrid kernel, Hardware Abstraction Layer (HAL), kernel drivers, and Executive. The higher-level services are implemented by the Executive portion, which interfaces with all the User Mode subsystems and deals with I/O, object management, security and process management.

Kernel Mode in the Windows NT line is made of subsystems capable of passing I/O requests to the appropriate Kernel Mode software drivers by using the I/O manager. Two subsystems make up the User Mode layer of Windows 2000: the Environment subsystem (runs applications written for many different types of operating systems), and the Integral subsystem (operates system specific functions on behalf of the environment subsystem). Kernel mode in Windows 2000 has full access to the hardware and system resources of the computer. The Kernel Mode stops user mode services and applications from accessing critical areas of the operating system that they should not have access to.

More specifically, the User Mode is made up of subsystems which can pass I/O requests to the appropriate Kernel Mode drivers via the I/O manager (which exists in Kernel Mode). Two subsystems make up the user mode layer of Windows 2000: the Environment subsystem and the Integral subsystem.

The environment subsystem was designed to run applications written for many different types of operating systems. None of the environment subsystems can directly access hardware, and must request access to memory resources through the Virtual Memory Manager that runs in Kernel Mode.

The integral subsystem looks after operating system specific functions on behalf of the environmental subsystem. It consists of a security service, a workstation service and a server service. The security service subsystem deals with security tokens, grants or denies access to user accounts based on resource permissions, handles logon requests and initiates logon authentication, determines which system resources need to be audited by Windows 2000, and looks after Active Directory. The workstation service is an API to the network redirector, which provides the computer access to the network. The server service is an API that allows the computer to provide network services.

Windows 2000® Kernel Mode has full access to the hardware and system resources of the computer and runs code in a protected memory area. Kernel Mode controls access to scheduling, thread prioritization, memory management and the interaction with hardware. The Kernel Mode stops User Mode services and applications from accessing critical areas of the operating system that they should not have access to as User Mode processes ask the Kernel Mode to perform such operations on its behalf.

In general, in a Windows operating system for example, a user performs tasks by accessing the system's resources via processes. When a user logs on to the Windows operating system and is authenticated, a security context is set up for that user based on the user's credentials and privileges assigned to that user. For example, an “administrative-level” user may be assigned the privilege that gives the user the ability to set the system clock through a particular application programming interface (API). If however, a currently logged-on user attempts to run a specific process that requires more privilege than the user is assigned, the system creates a request to the user for increased privilege that will then allow the process to launch successfully.

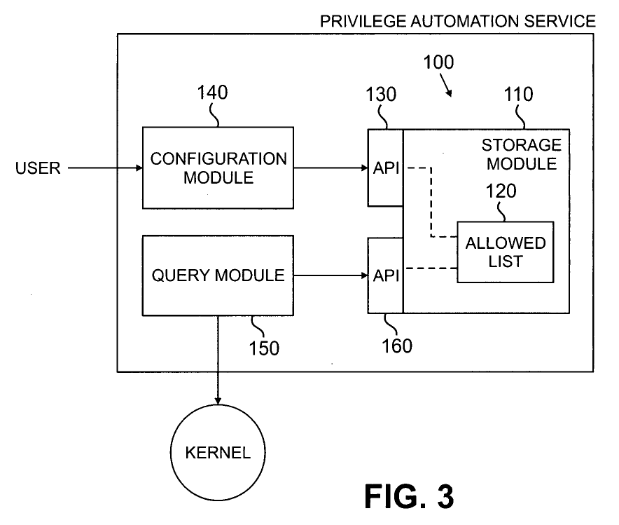

FIG. 3 is a block diagram illustrating the basic components of the privilege automation service that may be installed and configured to run in the context of the system for driving security decisions presented to a user by the operating system. The privilege automation service runs on top of the kernel, but still in system space. Specifically, as shown, the privilege automation service 100 includes a storage module 110 that includes an allowed list 120. This list 120 includes configuration information provided by a user through API 130 and configuration module 140. As described in greater detail below, the information includes identification information for the processes allowed to run, and also alternate user credentials that the processes may need in order to run. The privilege automation service further includes a query module 150 that is configured to query the kernel of the system to determine if process has been launched requiring additional privilege, and if so, the query module 150 determines through API 160 if the process is included in the allowed list 120.

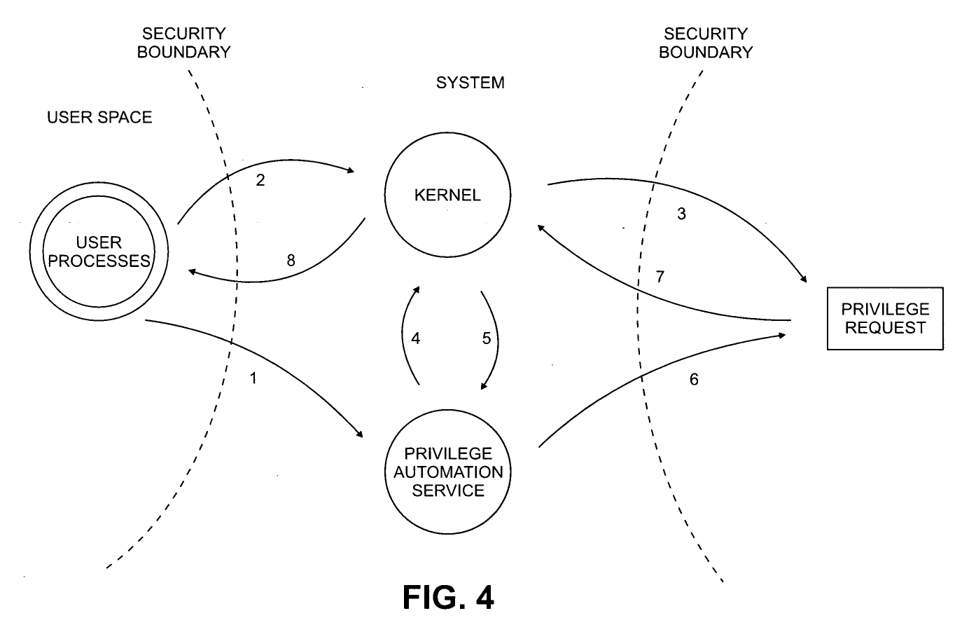

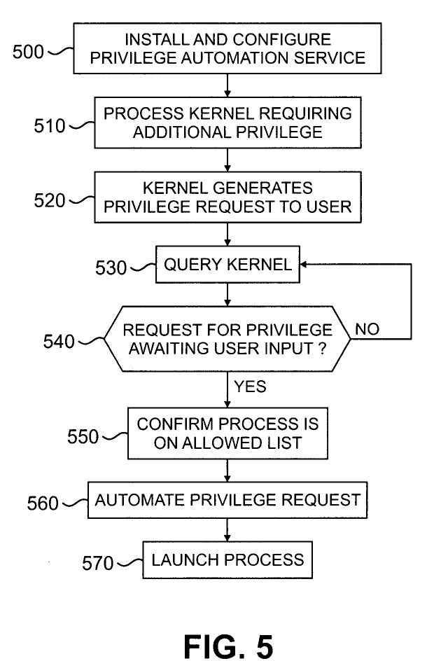

Turning to FIGS. 4 and 5, FIG. 4 is a state diagram and FIG. 5 is an exemplary process flowchart, each illustrating the proposed automation service as implemented within an operating system for programmatically responding to a privilege request on behalf of a user. First, as illustrated in step 500 of FIG. 5 (corresponding to line “1” of state diagram FIG. 4), the privilege automation service must be installed and configured to run in the context of the system. The user installs the proposed service and configures a list of allowed processes. To install the service, the user requires special privileges—but once installed and running, the service is already running with ‘special privileges’, so to configure the service, the user does not need special privileges.

With the service installed, a user without any special privilege can use an API to send configuration information to the service. This information contains identification information for the process that will be allowed to run and any information necessary for authentication (e.g., alternate user credentials) that the process may need in order to run. Since this information contains authentication information such as user credentials, the information is stored securely by the service so that the user credentials may only be used by the service.

For example, if a user wants to run the disk defragmenter as “user B”—when the user configures the service, he needs “user B's” user name and password in order to allow the service to actually launch the defragmenter as “user B”. In this way, any user on the system could then launch the defragmenter and it will run as “user B”—i.e., the service will always launch that process as user B. It automates launching that process (that requires more privilege) for all users and allows it so that they can all run it when they may not have been able to run the process beforehand and any security boundary for the privilege request is also automated. In addition, any processes initiated under the user's account have the same privileges as the user.

It should be noted that the privilege automation service can be configured to use one set of credentials for all processes, or specific credentials for each individual process.

Continuing to Step 510, with the service configured, a user then initiates a process launch (corresponding to line “2” of state diagram FIG. 4) that requires additional privilege (this process may or may not be included in the allowed process list provided by the user in the configuration step, Step 500).

Upon receipt of the user's request to launch the process, the operating system (i.e., the security mechanism therein) generates a privilege request to the user (Step 520, corresponding to line “3” of state diagram FIG. 4). While not necessary, for added security, the privilege request may be separated from the user space by a separate security boundary to provide better security for the privilege request (e.g. a UI or prompt for credentials).

Simultaneously, the privilege automation service repeatedly queries the kernel (Step 530, corresponding to line “4” of state diagram FIG. 4) to see if any requests for privilege are currently waiting for user input. Alternatively, if the operating system is designed to allow for such an option, the kernel can notify the privilege request service that a privilege request has been generated in Step 510, eliminating the need for the privilege automation service to query the kernel (Step 530 of the process).

If a determination is made in Step 540 that such a request is waiting for input, the service then checks to see if the process the request is for exists in the list of allowed processes (Step 550, corresponding to line “5” of state diagram FIG. 4).

If the process does not exist in the list, the kernel gives the user the opportunity to provide the necessary user credentials, and awaits a response from the user to the privilege request sent to the user in Step 520 (or line “3” of state diagram FIG. 4). If the user manually inputs the required user credentials in response to the privilege request generated in Step 520, the process will launch.

If however the process does exist in the list of allowed processes, the privilege automation service then automates the privilege request (Step 560, corresponding to lines “6” and “7” of state diagram FIG. 4). This automation can use a variety of current user interface automation techniques. The automation must query the User Interface that is currently being displayed to the User—i.e., the “request to the user”, to determine the type of question that the system asked for. For example, if the request is for user credentials, then the service will automate sending the user name and password through the User Interface to the kernel. The automation solution could be as simple as mimicking keyboard input to the kernel (as if the user) (e.g., the same techniques used for accessibility applications use to automate User Interfaces). Alternatively, the request can be a simple push button dialog where the service would automate clicking the button that confirms the request—for example, “do you want this to run with a higher level of privilege” or “do you not want this to run”?

With the privilege request answered, the system then launches the process using higher privilege or a different user (Step 570, corresponding to line “8” of state diagram FIG. 4)).

Various additional functionalities may be implemented to provide further desired upgrades to a user. For example, the privilege automation service could be configured to allow elevation of an application anywhere between one to N times, or, to always allow elevation of an application, or to never allow elevation of an application. In addition, the privilege automation service could be configured to allow elevation of an application only if the launch is within a predetermined time, for example, within the “next N minutes/hours/days”, or, to allow elevation of the application and then terminate elevation of that application after a predetermined time, or after “N minutes/hours/days”.

The privilege automation service techniques described herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” and “generate,” to describe computer operations in a computing environment. These terms are high-level abstractions for operations performed by a computer, and should not be confused with acts performed by a human being. The actual computer operations corresponding to these terms vary depending on implementation.

In view of the many possible embodiments to which the principles of the privilege automation service may be applied, we claim all such embodiments as may come within the scope and spirit of the following claims and equivalents thereto.

We claim:

1. A method for programmatically answering a privilege request from an operating system to allow a requested process to launch successfully, the method comprising the steps of:
receiving at the operating system a launch request from a user attempting to launch a process requiring additional privilege;
presenting a privilege request to the user;
querying a privilege automation service to determine if the privilege request is for a process included in an allowed list of processes; and
automating a response to the privilege request when the process is in the list of allowed processes to thereby allow the process to be launched.

2. The method of claim 1, wherein the kernel of the operating system receives the launch request and presents the privilege request to the user.

3. The method of claim 2, wherein the privilege automation service repeatedly monitors the kernel of the operating system to determine if a request to launch a process requiring additional privilege has been received.

4. The method of claim 2, wherein the kernel is configured to notify the privilege automation service of the receipt of a request to launch a process requiring additional privilege.

5. The method of claim 1, further comprising the step of installing and pre-configuring the privilege automation service within the operating system of the computing system.

6. The method of claim 5, wherein the privilege automation service includes configuration information including identification information for the processes allowed to run.

7. The method of claim 6, wherein the identification information includes user credentials.

8. The method of claim 7, wherein a plurality of user credentials are provided, with specific user credentials used for individual processes.

9. The method of claim 7, wherein a single set of user credentials is used for all processes.

10. A method for programmatically answering a privilege request from an operating system to allow a requested process to launch successfully, the method comprising the steps of:
monitoring the kernel of the operating system to determine if a request to launch a process requiring additional privilege has been received;
determining if the request is for a process included in an allowed list included in a storage mechanism; and
automating a response to the kernel providing the additional privilege required when the process is in the allowed list included in the storage mechanism.

11. The method of claim 10 further comprising the step of launching the requested process.

12. The method of claim 10, wherein the trusted entity is pre-configured to include identification information for a process allowed to run and user credentials needed to run the process.

13. The method of claim 11, wherein the step of automating the response further comprises determining a type of question generated to the user by the kernel upon receipt of the request to launch the process.

14. The method of claim 13, wherein if the type of question requires user credentials, the step of automating a response includes sending the user credentials provided in the pre-configured trusted entity.

15. The method of claim 13, wherein the step of automating a response includes mimicking keyboard input.

16. The method of claim 11, wherein the step of automating the response to the privilege request comprises confirming the request.

17. The method of claim 11, wherein the operating system is configured to notify the trusted entity of the receipt of a request to launch a process requiring additional privilege.

18. A privilege automation module embodied on a computer-readable medium having computer-executable instructions that, when executed by a computer, is configured to programmatically answer a privilege request from an operating system to allow a requested process to launch successfully, and employs an architecture comprising:
an interface configured to allow a user to provide configuration information to the module;
a storage module for storing the configuration information provided through said interface as an allowed list; and
a query module for monitoring the operating system for requests for processes requiring a privilege request, and, upon detecting such a request, interacting with the storage module to determine if the process is on the allowed list, to determine a necessary response based upon a type of question presented to the user requesting the process, and to automatically generate the necessary response to the operating system.

19. The privilege automation module of claim 18, wherein the allowed list includes a list of allowed processes and a list of pre-configured responses to security questions presented for each of the allowed processes.

20. The privilege automation module of claim 19, wherein the necessary response is a pre-configured response in the list of pre-configured responses.
